(19) United States
(12) Patent Application Publication
(10) Pub. No.: US 2011/0178220 A1
(43) Pub. Date: Jul. 21, 2011

(54) Moisture Curable Compositions

(76) Inventors: Delphine Davio, Le Roeulx (BE); Andreas Stammer, Pont-A-Celles (BE)

(21) Appl. No.: 12/809,308

(22) PCT Filed: Dec. 17, 2008
(86) PCT No.: PCT/EP2008/010754

§ 371 Date: Mar. 31, 2011

(30) Foreign Application Priority Data
Dec. 21, 2007 (GB) 0724914.7

(51) Int. Cl. C08K 3/34; C08L 83/04; C08L 67/00; C08L 75/04; C08L 71/00; C08K 3/26

(52) U.S. Cl. 524/425; 525/475; 525/342; 525/453; 524/588; 524/442; 524/451; 524/449

(57) ABSTRACT

A moisture curable composition comprising a polymer (A) containing reactive hydroxyl or hydrolysable groups bonded to silicon, which groups are reactive in the presence of moisture with each other or with groups in a crosslinking agent (B) present in the composition, characterized in that the composition is free from organic compounds of tin and contains kaolin as a catalyst for the reaction of the reactive groups of polymer (A). The kaolin is preferably calcined and most preferably is the only catalyst utilised during cure.

This invention relates to moisture curable compositions curing by the reaction of hydroxyl or hydrolysable groups bonded to silicone. Such compositions, generally comprising a polymer containing reactive hydroxyl or hydrolysable groups bonded to silicon and a crosslinking agent containing groups reactive with the reactive groups of the polymer in the presence of moisture, are used for example as ambient temperature curable sealants or coatings. These compositions are typically either prepared in the form of one-part compositions curable upon exposure to atmospheric moisture at room temperature or two part compositions curable upon mixing at room temperature.

In use as a sealant, it is important that the composition has a blend of properties which render it capable of being applied as a paste to a joint between substrate surfaces where it can be worked, prior to curing, to provide a smooth surfaced mass which will remain in its allotted position until it has cured into an elastomeric body adherent to the adjacent substrate surfaces. Typically sealant compositions are designed to cure quickly enough to provide a sound seal within several hours but at a speed enabling the applied material to be tooled into a desired configuration shortly after application.

The moisture curable compositions generally contain a metal organic compound as a catalyst for the reaction of the reactive groups of the polymer with the crosslinking agent. Although these groups react in the presence of moisture without catalyst, a metal organic compound catalyst is generally required to give cure, especially surface cure, in an acceptably short time. These metal organic compounds can be problematic for human health and the environment. Tin compounds, particularly diorganotin compounds such as dibutyltin dilaurate and dibutyltin diacetate, have been the most widely used catalysts for curing these moisture curable compositions, but there are now concerns about their continued use on health and environmental grounds.

DE-A-3439745 describes a sealant prepared from silicone with acetoxysilanes as crosslinking agents and dibutyltin diacetate as catalyst, and a silicate filler which has been surface treated with an organofunctional silane. The filler can for example be kaolinite, wollastonite, talc or barytes.

U.S. Pat. No. 4,929,664 describes a crosslinkable hydroxyl-terminated polydimethylsiloxane compounded with an oxime crosslinker, a tin catalyst and a platy talc reinforcing agent. JP 11-092729 describes a method for accelerating the cure of a sealant composition by additionally introducing an inorganic compound containing water of crystallization and using the water therefrom to enhance the speed of cure of the pre-prepared sealant formulation.

A moisture curable composition according to the present invention comprises a polymer (A) containing reactive hydroxyl or hydrolysable groups bonded to silicon which groups are reactive in the presence of moisture with each other or with groups in a crosslinking agent (B) present in the composition. The composition is free from organic compounds of tin and contains kaolin as a catalyst for the reaction of the reactive groups of polymer (A) with the crosslinking agent (B) in the presence of moisture.

According to a preferred aspect of the invention, the composition contains a crosslinking agent (B) containing groups reactive with the reactive groups of polymer (A) and the kaolin acts as a catalyst for the reaction of the reactive groups of crosslinking agent (B) with polymer (A) in the presence of moisture. Alternatively, where the hydroxyl or hydrolysable groups of polymer (A) are reactive with each other in the presence of moisture, the composition may contain no separate crosslinking agent.

Surprisingly, we have found that kaolin catalyses the moisture curing of the composition, as measured for example by skin over time and tack free time, without the use of a metal organic compound such as an organotin catalyst. The kaolin appears to act as a heterogeneous catalyst for moisture curing.

The invention thus includes the use of kaolin as a catalyst for the moisture curing of a composition comprising a polymer (A) containing reactive hydroxyl or hydrolysable groups bonded to silicon, which groups are reactive in the presence of moisture with each other or with groups in a crosslinking agent (B) present in the composition.

In one embodiment of the present invention the polymer (A) is a polysiloxane containing polymer containing at least two hydroxyl or hydrolysable groups, preferably terminal hydroxyl or hydrolysable groups. The polymer can for example have the general formula

X¹-A′-X² (1)

where X¹ and X² are independently selected from silicon containing groups which contain hydroxyl or hydrolysable substituents and A′ represents a polymer chain. Examples of X¹ or X² groups incorporating hydroxyl and/or hydrolysable substituents include groups terminating as described below:
—Si(OH)₃, —(R^{a})Si(OH)₂, —(R^{a})₂SiOH, —R^{a}Si(OR^{b})₂, —Si(OR^{b})₃, —R^{a}₂SiOR^{b} or —R^{a}₂Si—R^{c}—SiR^{d}ₚ(OR^{b})₃₋ₚ where each R^{a} independently represents a monovalent hydrocarbyl group, for example, an alkyl group, in particular having from 1 to 8 carbon atoms, (and is preferably methyl); each R^{b} and R^{d} group is independently an alkyl or alkoxy group in which the alkyl groups suitably have up to 6 carbon atoms; R^{c} is a divalent hydrocarbon group which may be interrupted by one or more siloxane spacers having up to six silicon atoms; and p has the value 0, 1 or 2.

The polymer chain A′ can for example be a siloxane-containing polymer chain such as an organopolysiloxane or a siloxane/organic block copolymeric molecular chain. Hydroxy-terminated organopolysiloxanes, particularly polydiorganosiloxanes, are widely used in sealants and are suitable for use in the present invention. Thus the polymer (A) preferably includes siloxane units of formula (2)

—(R⁵ₛSiO_{(4-s)/2})— (2)

in which each R⁵ is independently an organic group such as a hydrocarbon group having from 1 to 18 carbon atoms, a substituted hydrocarbon group having from 1 to 18 carbon atoms or a hydrocarbonoxy group having up to 18 carbon atoms and s has, on average, a value of from 1 to 3, preferably 1.8 to 2.2. In a substituted hydrocarbon group, one or more hydrogen atoms in a hydrocarbon group have been replaced with another substituent. Examples of such substituents include, but are not limited to, halogen atoms such as chlorine, fluorine, bromine, and iodine; halogen atom containing groups such as chloromethyl, perfluorobutyl, trifluoroethyl, and nonafluorohexyl; oxygen atoms; oxygen atom containing groups such as (meth)acrylic and carboxyl; nitrogen atoms; nitrogen atom containing groups such as amino-functional groups, amido-functional groups, and cyano-functional groups; sulphur atoms; and sulphur atom containing groups such as mercapto groups.

Preferably each R⁵ is a hydrocarbyl group having from 1 to 10 carbon atoms optionally substituted with one or more halogen group such as chlorine or fluorine and s is 0, 1 or 2. Particular examples of groups R⁵ include methyl, ethyl, propyl, butyl, vinyl, cyclohexyl, phenyl, tolyl group, a propyl group substituted with chlorine or fluorine such as 3,3,3-trifluoropropyl, chlorophenyl, beta-(perfluorobutyl)ethyl or chlorocyclohexyl group. Suitably, at least some and preferably substantially all of the groups R⁵ are methyl.

The polymer (A), particularly if it is a polydiorganosiloxane, may have a viscosity of up to 20,000,000 mPa·s, at 25° C. and may contain up to or even more than 200,000 units of formula (2). Polydiorganosiloxanes comprising units of the formula (2) may be homopolymers or copolymers in either block form or in a random continuation. Mixtures of different polydiorganosiloxanes are also suitable. In the case of polydiorganosiloxane co-polymers the polymeric chain may comprise a combination of blocks made from chains of units depicted in FIG. 2) above where the two R⁵ groups are:

both alkyl groups (preferably both methyl or ethyl), or

alkyl and phenyl groups, or

alkyl and fluoropropyl, or

alkyl and vinyl or

alkyl and hydrogen groups.

Typically at least one block will comprise siloxane units in which both R⁵ groups are alkyl groups.

The polymer (A) may alternatively have a block copolymeric backbone comprising at least one block of siloxane groups of the type depicted in formula (2) above and at least one block comprising any suitable organic polymer chain. The organic polymer backbone may comprise, for example, polyoxyalkylene, polystyrene and/or substituted polystyrenes such as poly(α-methylstyrene), poly(vinylmethylstyrene), dienes, poly(p-trimethylsilylstyrene) and poly(p-trimethylsilyl-α-methylstyrene). Other organic components which may be incorporated in the polymeric backbone may include acetylene terminated oligophenylenes, vinylbenzyl terminated aromatic polysulphones oligomers, aromatic polyesters, aromatic polyester based monomers, polyalkylenes, polyurethanes, aliphatic polyesters, aliphatic polyamides and aromatic polyamides.

The most preferred organic polymer blocks in a siloxane organic block copolymer (A) are polyoxyalkylene based blocks comprising recurring oxyalkylene units, illustrated by the average formula (—CₙH₂ₙ—O—)_{y} wherein n is an integer from 2 to 4 inclusive and y is an integer of at least four. The number average molecular weight of each polyoxyalkylene polymer block may range from about 300 to about 10,000. Moreover, the oxyalkylene units are not necessarily identical throughout the polyoxyalkylene block, but can differ from unit to unit. A polyoxyalkylene block, for example, can comprise oxyethylene units (—C₂H₄—O—), oxypropylene units (—C₃H₆—O—) or oxybutylene units (—C₄H₈—O—), or mixtures thereof. Preferably the polyoxyalkylene polymeric backbone consists essentially of oxyethylene units or oxypropylene units. Other polyoxyalkylene blocks may include for example: units of the structure—

-[—R^{e}—O—(—R^{f}—O—)ₕ—Pn-CR^{g}₂-Pn-O—(—R^{f}—O—)_{q}—R^{e}]—

in which Pn is a 1,4-phenylene group, each R^{e} is the same or different and is a divalent hydrocarbon group having 2 to 8 carbon atoms, each R^{f} is the same or different and is an ethylene group or propylene group, each R⁹ is the same or different and is a hydrogen atom or methyl group and each of the subscripts h and q is a positive integer in the range from 3 to 30.

The polymer (A) can alternatively be an organic polymer containing reactive hydroxyl or hydrolysable groups bonded to silicon. By an organic polymer we mean a material based on carbon chemistry, which is a polymer in which at least half the atoms in the polymer backbone are carbon atoms. The organic polymer is preferably a telechelic polymer having terminal moisture curable silyl groups containing reactive hydroxyl or hydrolysable groups bonded to silicon. The organic polymer can for example be selected from polyethers, hydrocarbon polymers, acrylate polymers, polyurethanes and polyureas.

One preferred type of polyether is a polyoxyalkylene polymer comprising recurring oxyalkylene units of the formula (—CₙH₂ₙ—O—) wherein n is an integer from 2 to 4 inclusive, as described above in connection with siloxane polyoxyalkylene block copolymers. Polyoxyalkylenes usually have terminal hydroxyl groups and can readily be terminated with moisture curable silyl groups, for example by reaction with an excess of an alkyltrialkoxysilane to introduce terminal alkyldialkoxysilyl groups. Alternatively polymerization may occur via a hydrosilylation type process. Polyoxyalkylenes consisting wholly or mainly of oxypropylene units have properties suitable for many sealant uses. Polyoxyalkylene polymers, particularly polyoxypropylenes, having terminal alkyldialkoxysilyl or trialkoxysilyl groups may be particularly suitable for use as a polymer (A) having reactive groups which react with each other in the presence of moisture and which do not need a separate crosslinking agent (B) in the composition.

Examples of silyl modified hydrocarbon polymers include silyl modified polyisobutylene, which is available commercially in the form of telechelic polymers. Silyl modified polyisobutylene can for example contain curable silyl groups derived from a silyl-substituted alkyl acrylate or methacrylate monomer such as a dialkoxyalkylsilylpropyl methacrylate or trialkoxysilylpropyl methacrylate, which can be reacted with a polyisobutylene prepared by living anionic polymerization, atom transfer radical polymerization or chain transfer polymerization.

The organic polymer having hydrolysable silyl groups can alternatively be an acrylate polymer, that is an addition polymer of acrylate and/or methacrylate ester monomers, which preferably comprise at least 50% by weight of the monomer units in the acrylate polymer. Examples of acrylate ester monomers are n-butyl, isobutyl, n-propyl, ethyl, methyl, n-hexyl, n-octyl and 2-ethylhexyl acrylates. Examples of methacrylate ester monomers are n-butyl, isobutyl, methyl, n-hexyl, n-octyl, 2-ethylhexyl and lauryl methacrylates. For sealant use, the acrylate polymer preferably has a glass transition temperature Tg below ambient temperature; acrylate polymers are generally preferred over methacrylates since they form lower Tg polymers. Polybutyl acrylate is particularly preferred. The acrylate polymer can contain lesser amounts of other monomers such as styrene, acrylonitrile or acrylamide. The acrylate(s) can be polymerized by various methods such as conventional radical polymerization, or living radical polymerization such as atom transfer radical polymerization, reversible addition—fragmentation chain transfer polymerization, or anionic polymerization including living anionic polymerization. The curable silyl groups can for example be derived from a silyl-substituted alkyl acrylate or methacrylate monomer. Hydrolysable silyl groups such as dialkoxyalkylsilyl or trialkoxysilyl groups can for example be derived from a dialkoxyalkylsilylpropyl methacrylate or trialkoxysilylpropyl methacrylate. When the acrylate polymer has been prepared by a polymerization process which forms reactive terminal groups, such as atom transfer radical polymerization, chain transfer polymerization, or living anionic polymerization, it can readily be reacted with the silyl-substituted alkyl acrylate or methacrylate monomer to form terminal hydrolysable silyl groups.

Silyl modified polyurethanes or polyureas can for example be prepared by the reaction of polyurethanes or polyureas having terminal ethylenically unsaturated groups with a silyl monomer containing hydrolysable groups and a Si—H group, for example a dialkoxyalkylsilicon hydride or trialkoxysilicon hydride.

The crosslinker (B) preferably contains at least two and preferably at least three groups reactive with the silicon-bonded hydroxyl or hydrolysable groups of polymer (A). The reactive groups of crosslinker (B) are themselves preferably silanol groups or silicon bonded hydrolysable groups, most preferably hydrolysable groups. The cross-linker can for example be a silane or short chain organopolysiloxane, for example a polydiorganosiloxane having from 2 to about 100 siloxane units. The molecular structure of such an organopolysiloxane can be straight chained, branched, or cyclic. The crosslinker (B) can alternatively be an organic polymer substituted by silicon-bonded hydrolysable groups.

The hydrolysable groups in the crosslinker can for example be selected from acyloxy groups (for example, acetoxy, octanoyloxy, and benzoyloxy groups); ketoximino groups (for example dimethyl ketoximo, and isobutylketoximino); alkoxy groups (for example methoxy, ethoxy, and propoxy) and/or alkenyloxy groups (for example isopropenyloxy and 1-ethyl-2-methylvinyloxy).

When the crosslinking agent (B) is a silane having three silicon-bonded hydrolysable groups per molecule, the fourth group is suitably a non-hydrolysable silicon-bonded organic group. These silicon-bonded organic groups are suitably hydrocarbyl groups which are optionally substituted by halogen such as fluorine and chlorine. Examples of such fourth groups include alkyl groups (for example methyl, ethyl, propyl, and butyl); cycloalkyl groups (for example cyclopentyl and cyclohexyl); alkenyl groups (for example vinyl and allyl); aryl groups (for example phenyl, and tolyl); aralkyl groups (for example 2-phenylethyl) and groups obtained by replacing all or part of the hydrogen in the preceding organic groups with halogen. Preferably the fourth silicon-bonded organic group is methyl or ethyl.

Examples of crosslinking agents (B) include acyloxysilanes, particularly acetoxysilanes such as methyltriacetoxysilane, vinyltriacetoxysilane, ethyl triacetoxysilane, di-butoxy diacetoxysilane and/or dimethyltetraacetoxydisiloxane, and also phenyl-tripropionoxysilane. The crosslinking agent can be an oxime-functional silane such as methyltris(methylethylketoximo)silane, vinyl-tris(methylethylketoximo)silane, or an alkoxytrioximosilane. The crosslinking agent can be an alkoxysilane, for example an alkyltrialkoxysilane such as methyltrimethoxysilane, methyltriethoxysilane, isobutyltrimethoxysilane or ethyltrimethoxysilane, an alkenyltrialkoxysilane such as vinyltrimethoxysilane or vinyltriethoxysilane, or phenyltrimethoxysilane, 3,3,3-trifluoropropyltrimethoxysilane, or ethylpolysilicate, n-propylorthosilicate, ethylorthosilicate, or an alkenyloxysilane such as methyltris(isopropenoxy)silane or vinyltris(isopropenoxy)silane. The crosslinking agent can alternatively be a short chain polydiorganosiloxane, for example polydimethylsiloxane, tipped with trimethoxysilyl groups or can be an organic polymer, for example a polyether such as polypropylene oxide, tipped with methoxysilane functionality such as trimethoxysilyl groups. The cross-linker used may also comprise any combination of two or more of the above.

Further alternative cross-linkers include alkylalkenylbis(N-alkylacetamido) silanes such as methylvinyldi-(N-methylacetamido)silane, and methylvinyldi-(N-ethylacetamido)silane; dialkylbis(N-arylacetamido) silanes such as dimethyldi-(N-methylacetamido)silane; and dimethyldi-(N-ethylacetamido)silane; alkylalkenylbis(N-arylacetamido) silanes such as methylvinyldi(N-phenylacetamido)silane and dialkylbis(N-arylacetamido) silanes such as dimethyldi-(N-phenylacetamido)silane, or any combination of two or more of the above.

The amount of crosslinking agent (B) present in the composition will depend upon the particular nature of the crosslinking agent, particularly its molecular weight. The compositions suitably contain crosslinker (B) in at least a stoichiometric amount as compared to the polymer (A). Compositions may contain, for example, from 2-30% by weight of crosslinker (B), generally from 2 to 10%. For example, acetoxysilane or oximinosilane crosslinkers may typically be present in amounts of from 3 to 8% by weight.

The kaolin is preferably calcined kaolin, that is kaolin which has been heated to remove its water of crystallization, although non-calcined kaolin or metakaolin can be used in some compositions according to the invention. Calcined kaolin is formed by heating kaolin to above 700° C., typically to 1000° C. Such heating generally produces a very white, high surface area mineral with an inert surface. Calcination can alternatively be carried out by the process called “flash calcination” leading to closed pores in the filler which are not accessible for a sealant or coating binder. The calcined kaolin used in this invention can be formed by either of these processes. Examples of preferred commercially available calcined kaolins include, products sold by, for example Imerys under the trade marks Polestar and Opalicite, by Australian China Clays under the trade mark Microbrite C80/95 and Burgess under the Trade Mark Ice white. Other calcined kaolin producers include Inner Mongolia Huasheng, Huber Minerals, Inner Mongolia Mengxi and Shanxi Jinyang Calcined Kaolin Co. Ltd. The calcined kaolin can be surface treated with an organic compound, for example a fatty acid or a fatty acid ester such as a stearate, or a basic organic compound as described in WO-A-2006/041929, or with an organosilane, organosiloxane or organosilazane to render the kaolin hydrophobic, but such treatment is not necessary for this invention. The kaolin generally has a median particle size by weight of at least 0.1 μm and less than 40 μm, preferably less than 5 μm, for example from 0.5 μm or 1 μm up to 5 μm.

As previously indicated the kaolin used in the present invention functions as a catalyst. The kaolin catalyses the moisture curing of the composition, as can be seen in the examples below, without the use of a metal organic compound such as an organotin catalyst. The kaolin appears to act as a heterogeneous catalyst for the moisture curing. The kaolin is preferably the only catalyst in the composition.

However, an additional advantage in using kaolin is that it also functions as a reinforcing filler. The kaolin is preferably present at 3 to 400 parts by weight per 100 parts of polymer (A) of the moisture curable composition, more preferably at 10 to 300 parts. The kaolin remains in the composition as dispersed solid particles and acts as a filler in the composition. Sealant compositions generally contain substantial amounts of solid filler and the kaolin thus forms all or part of the filler in a sealant composition according to the invention. Kaolin is an effective filler in sealant compositions, particularly those based on organopolysiloxanes, providing thixotropic properties and excellent mechanical properties such as high elongation at break, high Shore A hardness, tensile strength and high tear resistance. A sealant composition according to the invention can thus if desired be free of any reinforcing filler other than kaolin. In some preferred sealant compositions according to the invention, kaolin is the only filler in the composition or is the main filler, comprising for example 75 to 100% by weight of the filler in the composition. Alternatively the kaolin can form 5 to 75% by weight of the filler in the composition. If kaolin is not the only filler and is being used as a catalyst rather than for its reinforcing filler properties, the composition contains a second filler selected from those known in moisture curable sealant compositions.

The second filler can for example be a reinforcing filler such as high surface area fumed and precipitated silicas and to a degree precipitated calcium carbonate, and/or can comprise a non-reinforcing filler such as crushed quartz, ground calcium carbonate, diatomaceous earth, barium sulphate, iron oxide, titanium dioxide, carbon black, talc, crystobalite, mica, feldspar or wollastonite. Other fillers which might be used alone or in addition to the above include aluminite, calcium sulphate (anhydrite), gypsum, magnesium carbonate, aluminium trihydroxide, magnesium hydroxide (brucite), graphite, copper carbonate, e.g. malachite, nickel carbonate, barium carbonate, strontium carbonate, aluminium oxide, or silicates from the group consisting of the olivine group, the garnet group, aluminosilicates, ring silicates, chain silicates and sheet silicates, or plastic or glass microspheres, preferably hollow microspheres. The second filler, when present in the composition may be present in a preferred range of 3 to 400 parts by weight per 100 parts of polymer (A) of the moisture curable composition. In one preferred embodiment of the present invention the composition contains no silica (i.e. it is silica free).

The composition of the invention can include other ingredients known for use in moisture curable compositions based on silicon-bonded hydroxyl or hydrolysable groups such as sealant compositions. The composition may comprise a silicone or organic fluid which is not reactive with the polymer (A) or the crosslinking agent (B). Such a silicone or organic fluid acts as a plasticizer or extender (sometimes referred to as a processing aid) in the composition. The silicone or organic fluid can be present in up to 200 parts by weight of the moisture curable composition per 100 parts of polymer (A), for example from 5 or 10 parts by weight up to 150 parts by weight based on 100 parts by weight of polymer (A).

Examples of non-reactive silicone fluids useful as plasticizers include polydiorganosiloxanes such as polydimethylsiloxane having terminal triorganosiloxy groups wherein the organic substituents are, for example, methyl, vinyl or phenyl or combinations of these groups. Such polydimethylsiloxanes can for example have a viscosity of from about 5 to about 100,000 mPa·s at 25° C.

Examples of compatible organic plasticizers which can be used additionally to or instead of the silicone fluid plasticiser include dialkyl phthalates wherein the alkyl group may be linear and/or branched and contains from six to 20 carbon atoms such as dioctyl, dihexyl, dinonyl, didecyl, diallanyl and other phthalates, and analogous adipate, azelate, oleate and sebacate esters; polyols such as ethylene glycol and its derivatives; and organic phosphates such as tricresyl phosphate and/or triphenyl phosphates.

Examples of extenders for use in compositions according to the invention, particularly silicone sealant compositions, include mineral oil based (typically petroleum based) paraffinic hydrocarbons, mixtures of paraffinic and naphthenic hydrocarbons, paraffin oils comprising cyclic paraffins and non-cyclic paraffins and hydrocarbon fluids containing naphthenics, polycyclic naphthenics and paraffins, or polyalkylbenzenes such as heavy alkylates (alkylated aromatic materials remaining after distillation of oil in a refinery). Examples of such extenders are discussed in GB2424898 the content of which is hereby enclosed by reference. Such a hydrocarbon extender can for example have an ASTM D-86 boiling point of from 235° C. to 400° C. An example of a preferred organic extender is the hydrocarbon fluid sold by Total under the trade mark G250H. The extender or plasticiser may comprise one or more non-mineral based natural oil, i.e. an oil derived from animals, seeds or nuts and not from petroleum, or a derivative thereof such as a transesterified vegetable oil, a boiled natural oil, a blown natural oil, or a stand oil (thermally polymerized oil).

Other ingredients which may be included in the compositions include but are not restricted to rheology modifiers; adhesion promoters, pigments, heat stabilizers, flame retardants, UV stabilizers, chain extenders, cure modifiers, electrically and/or heat conductive fillers, and fungicides and/or biocides and the like.

The rheology modifiers include silicone organic co-polymers such as those described in EP 0802233 based on polyols of polyethers or polyesters; non-ionic surfactants selected from the group consisting of polyethylene glycol, polypropylene glycol, ethoxylated castor oil, oleic acid ethoxylate, alkylphenol ethoxylates, copolymers or ethylene oxide and propylene oxide, and silicone polyether copolymers; as well as silicone glycols. For some systems these rheology modifiers, particularly copolymers of ethylene oxide and propylene oxide, and silicone polyether copolymers, may enhance the adhesion of the sealant to substrates, particularly plastic substrates.

Examples of adhesion promoters which may be incorporated in moisture curable compositions according to the invention include alkoxysilanes such as aminoalkylalkoxysilanes, for example 3-aminopropyltriethoxysilane, epoxyalkylalkoxysilanes, for example, 3-glycidoxypropyltrimethoxysilane and, mercapto-alkylalkoxysilanes, and reaction products of ethylenediamine with silylacrylates. Isocyanurates containing silicon groups such as 1,3,5-tris(trialkoxysilylalkyl) isocyanurates may additionally be used. Further suitable adhesion promoters are reaction products of epoxyalkylalkoxysilanes such as 3-glycidoxypropyltrimethoxysilane with amino-substituted alkoxysilanes such as 3-aminopropyltrimethoxysilane and optionally with alkylalkoxysilanes such as methyltrimethoxysilane.

Heat stabilizers may include iron oxides and carbon blacks, iron carboxylate salts, cerium hydrate, barium zirconate, cerium and zirconium octoates, and porphyrins. Flame retardants may include hydrated aluminium hydroxide and silicates such as wollastonite.

Chain extenders may include difunctional silanes which extend the length of the polysiloxane polymer chains before cross linking occurs and, thereby, reduce the modulus of elongation of the cured elastomer. Chain extenders and crosslinkers compete in their reactions with the functional polymer ends; in order to achieve noticeable chain extension, the difunctional silane must have substantially higher reactivity than the trifunctional crosslinker with which it is used. Suitable chain extenders include diamidosilanes such as dialkyldiacetamidosilanes or alkenylalkyldiacetamidosilanes, particularly methylvinyldi(N-methylacetamido)silane, or dimethyldi(N-methylacetamido)silane, diacetoxysilanes such as dialkyldiacetoxysilanes or alkylalkenyldiacetoxysilanes, diaminosilanes such as dialkyldiaminosilanes or alkylalkenyldiaminosilanes, dialkoxysilanes such as dimethoxydimethylsilane, diethoxydimethylsilane and α-aminoalkyldialkoxyalkylsilanes, polydialkylsiloxanes having a degree of polymerization of from 2 to 25 and having at least two acetamido or acetoxy or amino or alkoxy or amido or ketoximo substituents per molecule, and diketoximinosilanes such as dialkylkdiketoximinosilanes and alkylalkenyldiketoximinosilanes.

Electrically conductive fillers may include carbon black, metal particles such as silver particles any suitable electrically conductive metal oxide fillers such as titanium oxide powder whose surface has been treated with tin and/or antimony, potassium titanate powder whose surface has been treated with tin and/or antimony, tin oxide whose surface has been treated with antimony, and zinc oxide whose surface has been treated with aluminium. Thermally conductive fillers may include metal particles such as powders, flakes and colloidal silver, copper, nickel, platinum, gold aluminium and titanium, metal oxides, particularly aluminium oxide (Al₂O₃) and beryllium oxide (BeO); magnesium oxide, zinc oxide, zirconium oxide.

Fungicides and biocides include N-substituted benzimidazole carbamate, benzimidazolylcarbamate such as methyl 2-benzimidazolylcarbamate, ethyl 2-benzimidazolylcarbamate, isopropyl 2-benzimidazolylcarbamate, methyl N-{2-[1-(N,N-dimethylcarbamoyl)benzimidazolyl]}carbamate, methyl N-{2-[1-(N,N-dimethylcarbamoyl)-6-methylbenzimidazolyl]}carbamate, methyl N-{2-[1-(N,N-dimethylcarbamoyl)-5-methylbenzimidazolyl]}carbamate, methyl N-{2-[1-(N-methylcarbamoyl)benzimidazolyl]}carbamate, methyl N-{2-[1-(N-methylcarbamoyl)-6-methylbenzimidazolyl]}carbamate, methyl N-{2-[1-(N-methylcarbamoyl)-5-methylbenzimidazolyl]}carbamate, ethyl N-{2-[1-(N,N-dimethylcarbamoyl)benzimidazolyl]}carbamate, ethyl N-{2-[2-(N-methylcarbamoyl)benzimidazolyl]}carbamate, ethyl N-{2-[1-(N,N-dimethylcarbamoyl)-6-methylbenzimidazolyl]}carbamate, ethyl N-{2-[1-(N-methylcarbamoyl)-6-methylbenzimidazolyl]}carbamate, isopropyl N-{2-[1-(N,N-dimethylcarbamoyl)benzimidazolyl]}carbamate, isopropyl N-{2-[1-(N-methylcarbamoyl)benzimidazolyl]}carbamate, methyl N-{2-[1-(N-propylcarbamoyl)benzimidazolyl]}carbamate, methyl N-{2-[1-(N-butylcarbamoyl)benzimidazolyl]}carbamate, methoxyethyl N-{2-[1-(N-propylcarbamoyl)benzimidazolyl]}carbamate, methoxyethyl N-{2-[1-(N-butylcarbamoyl)benzimidazolyl]}carbamate, ethoxyethyl N-{2-[1-(N-propylcarbamoyl)benzimidazolyl]}carbamate, ethoxyethyl N-{2-[1-(N-butylcarbamoyl)benzimidazolyl]}carbamate, methyl N-{2-[1-(N,N-dimethylcarbamoyloxy)benzimidazolyl]}carbamate, methyl N-{2-[N-methylcarbamoyloxy)benzimidazolyl]}carbamate, methyl N-{2-[1-(N-butylcarbamoyloxy)benzoimidazolyl]}carbamate, ethoxyethyl N-{2-[1-(N-propylcarbamoyl)benzimidazolyl]}carbamate, ethoxyethyl N-{2-[1-(N-butylcarbamoyloxy)benzoimidazolyl]}carbamate, methyl N-{2-[1-(N,N-dimethylcarbamoyl)-6-chlorobenzimidazolyl]}carbamate, and methyl N-{2-[1-(N,N-dimethylcarbamoyl)-6-nitrobenzimidazolyl]}carbamate. 10,10′-oxybisphenoxarsine (trade name: Vinyzene, OBPA), di-iodomethyl-para-tolylsulfone, benzothiophene-2-cyclohexylcarboxamide-S,S-dioxide, N-(fluordichloridemethylthio)phthalimide (trade names: Fluor-Folper, Preventol A3). Methyl-benzimideazol-2-ylcarbamate (trade names: Carbendazim, Preventol BCM), Zinc-bis(2-pyridylthio-1-oxide) (zinc pyrithion) 2-(4-thiazolyl)-benzimidazol, N-phenyl-iodpropargylcarbamate, N-octyl-4-isothiazolin-3-on, 4,5-dichloride-2-n-octyl-4-isothiazolin-3-on, N-butyl-1,2-benzisothiazolin-3-on and/or Triazolyl-compounds, such as tebuconazol in combination with zeolites containing silver. The fungicide and/or biocide may suitably be present in an amount of from 0 to 0.3% by weight of the composition.

The moisture curable compositions can be prepared by mixing the ingredients employing any suitable mixing equipment. For example, preferred one-part moisture curable compositions may be made by preparing polymer (A) in the presence of a non-reactive silicone or organic fluid extender or plasticizer, or premixing the polymer (A) with an extender or plasticizer, and mixing the resulting extended polysiloxane with all or part of the filler used, and mixing this with a pre-mix of the crosslinking agent and the kaolin. Other additives such as UV stabilisers and pigments may be added to the mixture at any desired stage. The final mixing step is carried out under substantially anhydrous conditions, and the resulting curable compositions are generally stored under substantially anhydrous conditions, for example in sealed containers, until required for use.

Such one-part moisture curable compositions according to the invention are stable in storage but cure on exposure to atmospheric moisture produce elastomeric bodies which and may be employed in a variety of applications, for example as coating, caulking, mold making and encapsulating materials. They are particularly suitable for sealing joints, cavities and other spaces in articles and structures which are subject to relative movement. They are thus particularly suitable as glazing sealants and for sealing building structures where the visual appearance of the sealant is important.

The kaolin used in such a one-part moisture curable composition is calcined kaolin. The water of crystallization present in non-calcined kaolin, even in metakaolin, may cause premature curing of the composition on storage.

The moisture curable composition of the invention can alternatively be a two-part composition in which the polymer (A) and the crosslinking agent (B) are packaged separately. In such a composition the kaolin can in general be packaged with either the polymer (A) or with the crosslinking agent (B), but it is preferred that the kaolin is packaged with polymer (A), particularly if the kaolin is not calcined. Both packages in such a two-part composition can be anhydrous for curing on exposure to atmospheric moisture, or one only of the packages may contain a controlled amount of moisture to speed up initial cure of the composition on mixing of the packages. In a two-part composition the kaolin can be non-calcined kaolin or metakaolin, although calcined kaolin is still preferred. Such 2 part systems are mixed immediately prior to use. Typically they are mixed in ratios (Polymer A mix to cross-linker mix) of 1:10 to 10:1.

The composition in accordance with the present invention will provide an elastomeric body upon curing and preferably the elastomeric body is used as a sealant.

The invention is illustrated by the following Examples, in which parts and percentages are by weight. All viscosities of starting materials are given as pre-measured values provided by suppliers and viscosity measurements taken during experiments were measured using a Brookfield® HB DV-II+PRO with a cone plate spindle at a speed of 5 rpm. All viscosity measurements were taken at 25° C. unless otherwise indicated.

In Examples 1 to 9, the Polymer used was a dihydroxy terminated polydimethylsiloxane with a viscosity of 80000 mPas at 25° C. The Crosslinker was a mixture of approximately equal amounts of methyltriacetoxysilane and ethyltriacetoxysilane. The Extender was a mineral oil product sold by Total under the trade mark G250H. Moisture curable sealant compositions were prepared by mixing the ingredients listed in a Hausschild laboratory mixer (dental mixer) and filling the mixed composition into cartridges. The compositions were tested after 24 hours storage in the cartridge at ambient temperature.

The Skin over time (SOT) was measured by a finger test. The time required for the sealant not to leave any sealant traces at the finger, after gently touching the sealant surface, was recorded as SOT in minutes. The Tack free time (TFT), the time required for the sealant not to be tacky to the touch was tested by applying a polyethylene sheet to the sealant (the time required for the sealant not to leave any sealant trace on the sheet) and results are provided in minutes (min.). The cure in depth tests (CID) were undertaken to determine how far the surface of the sealant had hardened in 24 (CID24) and 72 hours (CID72) by filling a suitable container with sealant, curing the sealant contained in the container for the appropriate period of time at room temperature (RT) and 50% relative humidity. Afterwards the cured sealant skin is removed and the thickness of the cured sealant is given in mm. Penetration was measured according to ASTM D127-97, values are given in mm/10 for a measurement of 3 s. The stringing of the sealant is determined by measuring the maximum length of a string which can be pulled from the surface of a sample using a plastic nozzle and a tensiometer pulling with a speed of 1000 mm/min. Extrusion is the rate of extrusion in g/min. measured using a calibrated metal nozzle with a inner diameter of 5 mm of and a length of 90 mm and applying a pressure of 0.8 bar (0.8×10⁵ Pa) to the cartridge. Flow in mm was measured by means of a flow jig after 15 minutes according to ASTM D 2202.

The tensile tests were performed in accordance with ASTM D412-98a with 3 mm sheets after 1 week cure according to ASTM D412-98a.

‘Tensile’ means tensile strength (breaking stress) in MPa. ‘Modulus 100%’ is the nominal stress (or apparent stress, in MPa) at 100% elongation.
Elongation is given in % according to ASTM D412-98 a for 2 mm sheets.

The Hardness was Shore A hardness measured according to ASTM D2240-02b.

The tear strength in kN/m was measured by ASTM D 624 using Die B.

The tensile properties were tested with 3 mm sheets after 1 week cure according to ASTM D412-98a.

### EXAMPLES 1 AND 2

Moisture curable sealant compositions were prepared with the formulations shown in Table 1. Calcined Kaolin A had median particle size 1.5 μm (Malvern), surface area BET 16 g/m² (BET) and oil absorption 80 ml/100 g (ISO 787). In Comparative Examples C1 and C2, moisture curable sealant compositions were prepared from similar formulations but containing the known catalyst dibutyltin dilaurate (DBTDL).

The properties of the compositions when tested as described above are also given in Table 1.

TABLE 1

| | | | Comparative | Comparative |
|---|---|---|---|---|
| | Example 1 | Example 2 | Example C1 | Example C2 |
| Polymer | 31% | 30% | 30.98% | 29.98% |
| Extender | 25% | 25% | 25% | 25% |
| Crosslinker | 4% | 5% | 4% | 5% |
| DBTDL | 0% | 0% | 0.02% | 0.02% |
| Calcined Kaolin A | 40% | 40% | 40% | 40% |

Properties

| | | | | |
|---|---|---|---|---|
| SOT | 19 | 16 | 18 | 17 |
| TFT | 19 | 23 | 19 | 20 |
| CID 24 | 1.86 | 1.45 | 1.96 | 1.36 |
| CID 72 | 3.58 | 2.66 | 4.21 | 2.75 |
| Tensile strength | 3.38 | 2.96 | 3.27 | 2.85 |
| (MPa) | | | | |
| Elongation at break | 473 | 379 | 460 | 384 |
| (%) | | | | |
| 100% Modulus | 0.75 | 0.86 | 0.77 | 0.83 |
| (MPa) | | | | |

The SOT and TFT results in Table 1 show that the sealant compositions containing calcined kaolin but no DBTDL have a similar surface cure to the same sealant compositions containing DBTDL. The kaolin acts as an effective catalyst without the need for any additional catalyst. The mechanical properties of the cured sealants are not affected by removing the tin catalyst from the formulation.

### EXAMPLES 3 TO 8

Moisture curable sealant compositions were prepared with the formulations shown in Table 2, in which calcined kaolin was present in conjunction with a second filler Talc A, which is talc sold by Alpha Calcit under the trade mark Alpha CT 15P. The properties of the compositions when tested as described above are also given in Table 2.

TABLE 2

| | Example 3 | Example 4 | Example 5 | Example 6 | Example 7 | Example 8 |
|---|---|---|---|---|---|---|
| Polymer | 31% | 30% | 31% | 30% | 31% | 30% |
| Extender | 25% | 25% | 25% | 25% | 25% | 25% |
| Crosslinker | 4% | 5% | 4% | 5% | 4% | 5% |
| Catalyst | 0% | 0%- | 0% | 0% | 0% | 0% |
| Calcined Kaolin | 30% | 30% | 20% | 20% | 10% | 10% |
| A | | | | | | |
| Talc A | 10% | 10% | 20% | 20% | 30% | 30% |

Properties

| | | | | | | |
|---|---|---|---|---|---|---|
| SOT | 19 | 19 | 22 | 22 | 25 | 25 |
| TFT | 22 | 22 | 23 | 26 | 29 | 32 |
| CID 24 | 1.52 | 1.06 | 1.73 | 1.25 | 1.68 | 1.17 |
| CID 72 | 2.46 | 1.85 | 1.82 | 2.11 | 2.86 | 4 |
| Tensile (MPa) | 2.32 | 2.53 | 1.82 | 1.88 | 1.62 | 1.58 |
| Elongation at | 401 | 466 | 355 | 401 | 360 | 392 |
| break (%) | | | | | | |
| 100% Modulus | 0.67 | 0.69 | 0.61 | 0.62 | 0.57 | 0.53 |
| (MPa) | | | | | | |

Examples 3 to 8 show that even with only 10% of calcined kaolin in a moisture curable composition (with no other catalyst present) a sufficient cure speed can be obtained.

### EXAMPLE 9

The talc, designated Talc B in Table 3 was obtained from Rio Tinto Minerals under the trademark Mistron Monomix G.

Example 9 shows that a composition in accordance with the present invention comprising calcined kaolin as the only catalyst (i.e. no tin catalyst) is shelf stable.

TABLE 3

| Formulation | Example 9 |
|---|---|
| Polymer | 40.5% |
| Organic extender | 15% |
| Crosslinker | 4.5% |
| Catalyst | 0% |
| Talc B | 20% |
| Calcined Kaolin A | 20% |

Properties after 1 week at RT

| | |
|---|---|
| Penetration | 217 |
| Stringing | 43 |
| Extrusion | 320 |
| SOT | 20 |
| TFT | 23 |
| Flow | 1 |
| Tensile (sheet 2 mm) MPa | 3.06 |
| Elongation at break | 395 |
| Modulus 100% MPa | 1.05 |
| Hardness | 35 |
| Tear Die B | 7.13 |

Properties after ageing for 28 days at 50° C.

| | |
|---|---|
| Penetration | 204 |
| Stringing | 44 |
| Extrusion | 304 |
| SOT | 28 |
| TFT | 36 |
| Flow | 1 |
| Tensile (sheet 2 mm) MPa | 2.66 |
| Elongation at break | 291 |
| Modulus 100% MPa | 1.18 |
| Hardness | 37 |
| Tear Die B | 10.37 |

### COMPARATIVE EXAMPLES C3 TO C6

Example 2 was repeated using various other materials known as fillers, as listed in Table 3, in place of the kaolin. Talc B and Talc C were platy talcs sold by Rio Tinto Minerals under the trade marks Mistron Monomix G and Mistron 754G respectively. The crystobalite was supplied by Sibelco under the trade mark M3000. The properties of the compositions when tested as described above are also given in Table 4.

TABLE 4

| | C3 | C4 | C5 | C6 |
|---|---|---|---|---|
| Filler used | Talc A | Talc B | Talc C | Cristobalite |
| Polymer | 30% | 30% | 30% | 30% |
| Organic extender | 25% | 25% | 25% | 25% |
| Crosslinker | 5% | 5% | 5% | 5% |
| Catalyst | 0% | 0% | 0% | 0% |
| Filler | 40% | 40% | 40% | 40% |

Properties

| | | | | |
|---|---|---|---|---|
| SOT | 62 | 50 | 66 | 64 |
| TFT | 62 | 45 | 66 | 79 |
| CID 24 | 1.87 | 1.61 | 1.45 | 0.91 |
| CID 72 | 3.59 | 2.73 | 2.33 | 1.93 |
| Tensile (MPa) | 1.2 | 1.7 | 0.93 | 0.43 |
| Elongation at break | 359 | 494 | 473 | 211 |
| (%) | | | | |
| 100% Modulus (MPa) | 0.38 | 0.42 | 0.22 | 0.24 |

Comparative Examples C3 to C6 show that even at 40% loading other fillers do not provide the fast surface cure seen in sealant compositions containing kaolin.

### EXAMPLE 10 AND COMPARATIVE EXAMPLES C7 TO C9

Moisture curable sealant compositions were prepared by mixing the ingredients listed in a Hausschild laboratory mixer. The cure system used was oxime cure. The Polymer used was a dihydroxy terminated polydimethylsiloxane with a viscosity of 50000 mPas at 25° C. The Crosslinker was a vinyl-tris(methylethylketoximo)silane (VOS). The catalyst used in the comparative example C 7 was dibutyltindilaurate (DBTDL). The ground calcium carbonate (GCC) used in comparative example C 9 was supplied by Provencale under the tradename Mikhart AC. The silica used in comparative examples C7 and C8 was a fumed silica with a BET surface area of approx. 150 m²/g. The Silicone oil was a trimethylsilyl-terminated polydimethylsiloxane of viscosity 100 mPas at 25° C. The kaolin was the calcined kaolin A as described in example 1

TABLE 5

| | C7 | C8 | C9 | E10 |
|---|---|---|---|---|
| Filler | Silica | Silica | GCC | Calcined |
| | | | | Kaolin A |
| Polymer | 66.9% | 67% | 35% | 35% |
| Silicone Oil | 20% | 20% | 20% | 20% |
| Crosslinker | 5% | 5% | 5% | 5% |
| Catalyst | 0.1% | — | — | — |
| Filler | 8% | 8% | 40% | 40% |

Properties

| | | | | |
|---|---|---|---|---|
| SOT | 14 | 24 | >3 h 30 | 10 |
| TFT | 20 | 1 h 10 | >3 h 30 | 20 |
| CID 24 | 4.79 | 4.88 | 2.26 | 3.30 |
| CID 72 | 9.12 | 10.35 | 4.21 | 5.84 |
| Tensile (MPa) | 1.96 | 1.93 | 0.28 | 2.32 |
| Elongation at break | 339 | 319 | 439 | 298 |
| (%) | | | | |
| 100% Modulus (MPa) | 0.49 | 0.53 | 0.13 | 0.86 |

Comparative Examples C7 shows the properties of a typical oxime sealant containing a tin catalyst. C8 shows that without tin catalyst the surface cure is reduced to a level not suited for practical reasons (long tackiness). Examples E10 show that with calcined kaolin as a catalyst surface cure even faster than for tin containing oxime sealants can be obtained. Comparative example C9 shows that high amounts of other filler, in this case calcium carbonate, do not have the same effect on surface cure in oxime sealants

1. A moisture curable composition comprising a polymer (A) containing reactive hydroxyl or hydrolysable groups bonded to silicon, which groups are reactive in the presence of moisture with each other or with groups in a crosslinking agent (B), optionally present in the composition, characterized in that the composition is free from organic compounds of tin and contains kaolin as a catalyst for the reaction of the reactive groups of polymer (A).

2. A composition according to claim 1, characterized in that the crosslinking agent (B) is present in the composition and contains groups reactive with the reactive groups of polymer (A), and the kaolin acts as a catalyst for the reaction of the reactive groups of crosslinking agent (B) with polymer (A) in the presence of moisture.

3. A composition according to claim 1, characterized in that the kaolin is calcined kaolin.

4. A composition according to claim 1, characterized in that the kaolin has a median particle size by weight of 0.1 to 40 μm.

5. A composition according to claim 4, characterized in that the kaolin has a median particle size by weight of 1 to 5 μm.

6. A composition according to claim 1, characterized in that the kaolin is present in a range of from 3 to 400 parts by weight per 100 parts of polymer (A).

7. A composition according to claim 1, characterized in that the polymer (A) is an organopolysiloxane.

8. A composition according to claim 7, characterized in that the organopolysiloxane is a hydroxy-terminated polydiorganosiloxane.

9. A composition according to claim 1, characterized in that the polymer (A) is an organic polymer selected from polyethers, hydrocarbon polymers, acrylate polymers, polyurethanes and polyureas.

10. A composition according to claim 9, characterized in that the organic polymer is a telechelic polymer having terminal hydrolysable silyl groups.

11. A composition according to claim 2, characterized in that the crosslinking agent (B) is an acetoxysilane.

12. A composition according to claim 2, characterized in that the crosslinking agent (B) is an oxime-functional silicon compound.

13. A composition according to claim 2, characterized in that the crosslinking agent (B) is an alkoxysilane.

14. A composition according to claim 1, characterized in that the composition further comprises a silicone or organic fluid which is not reactive with the polymer (A) or the crosslinking agent (B).

15. A one-part composition according to claim 3, characterized in that the polymer (A), crosslinking agent (B) and calcined kaolin are packaged together in the absence of moisture.

16. A two-part composition according to claim 2, characterized in that the polymer (A) and the crosslinking agent (B) are packaged separately, the kaolin being packaged together with the polymer (A), and the crosslinking agent (B) being packaged with water.

17. A two-part composition according to claim 2, characterized in that the polymer (A) and the crosslinking agent (B) are packaged separately, the kaolin being packaged together with the crosslinking agent (B), and the polymer (A) being packaged with water.

18. An elastomeric body comprising a composition according to claim 2 comprising the polymer (A), the crosslinking agent (B) and a filler, characterized in that the kaolin forms 75 to 100% by weight of the filler in the composition.

19. An elastomeric body comprising a composition according to claim 2 comprising the polymer (A), the crosslinking agent (B) and a filler, characterized in that the kaolin forms 10 to 75% by weight of the filler in the composition and the composition also contains a filler selected from silica, calcium carbonate and silicate fillers other than kaolin.

20. An elastomeric body according to claim 19, characterized in that the silicate filler is talc, crystobalite, mica, feldspar or wollastonite.

21. An elastomeric body according to claim 18, characterised in that the elastomeric body is a sealant.

22. A composition according to claim 1, characterized in that the hydroxyl or hydrolysable groups of polymer (A) are reactive with each other in the presence of moisture and the composition contains no separate crosslinking agent.

23-25. (canceled)
